(19) United States
(12) Patent Application Publication
(10) Pub. No.: US 2026/0192399 A1
(43) Pub. Date: Jul. 9, 2026

(54) LASER ABLATION OF ELECTROSTATIC CHUCKS

(71) Applicant: Applied Materials, Inc., Santa Clara, CA (US)

(72) Inventors: Jamison Jew, San Francisco, CA (US); Wei-Sheng Lei, San Jose, CA (US); Daniel L. Martin, San Jose, CA (US); Robert T. Hirahara, San Jose, CA (US); Jongwoo Choi, San Jose, CA (US); Yifan Xia, San Jose, CA (US)

(73) Assignee: Applied Materials, Inc., Santa Clara, CA (US)

(21) Appl. No.: 19/010,831

(22) Filed: Jan. 6, 2025

(51) Int. Cl. B23K 26/40

(52) U.S. Cl. CPC B23K 26/40

(57) ABSTRACT

A method to refurbish electrostatic chucks includes identifying one or more layers on a minimal contact area (MCA) pad affixed to an electrostatic chuck, configuring a laser ablation system to remove the identified layers, ablating the identified layers with a controlled laser beam from the laser ablation system, identifying one or more deposited metals on the electrostatic chuck, and ablating the identified deposited metals with the laser beam. In another aspect, the MCA pad may include a diamond like carbon layer and a Ti-TiN layer. The laser ablation process removes the layers and deposited metals on an electrostatic chuck in a manner that is performed faster, with a lower cost, and without the use of a multistep chemical process compared to conventional chemical stripping methods.

### FIELD OF THE DISCLOSURE

The embodiments of the present disclosure relate to methods and systems to refurbish electrostatic chucks and, in particular, to a laser ablation system that removes MCA pads and deposited metals from an electrostatic chuck.

### BACKGROUND

An electrostatic chuck (ESC) is an important consumable part used in semiconductor manufacturing equipment and other related industries. ESCs may be used to hold wafers securely during processes such as chemical vapor deposition or physical vapor deposition. ESCs typically are manufactured with a substrate base constructed of ceramic, metal, or any other suitable material, and a minimum contact area (MCA) pad that serves as a wafer support structure minimizing wafer to ceramic contact. ESCs generate an electrostatic force that attracts and holds objects securely without the need for mechanical clamping or vacuum holding. When voltage is applied, the ESC generates an electric field that induces opposite charges on the ESC and the object to be held. The resulting electrostatic attraction holds the object firmly on the ESC.

ESCs may be manufactured with a substrate constructed of a material such as aluminum nitride (AlN) or aluminum oxide. The MCA pad may include, but not be limited to, layers applied to a top surface of the substrate including a diamond like carbon (DLC) pad and/or a titanium and titanium nitride thin film layer (Ti/TiN). In an example, the ESC may include a center circuit pad constructed of an additional DLC coating, a Ti/TiN Layer, and/or any other suitable materials. In an example, the center circuit pad may have a different shape and/or thickness than the MCA pad.

The layers may have various thicknesses based on the type of ESC and the function for which the ESC is being used. For example, the DLC pad layer may be less than 10 um thick. The Ti/TiN layer may be less than 10 um thick. The center circuit pads may be 0.1 um to 5 um thick.

ESCs are typically refurbished and reused. The refurbishment process seeks to remove all the applied thin film material stacks of the MCA pad and build new stacks on a clean and smooth substrate surface. Conventional systems use a chemical process that may include deposited metals removal, such as removal of copper, chemical stripping to remove the applied layers, and surface polishing. In addition to removing the applied layers, ESC refurbishment seeks to remove metals deposited on the ESC during various metal/dielectric deposition processes for device fabrication on wafers. These metal deposits on ESCs are contaminants to be removed before the ESC may be reused.

The conventional chemical refurbishment process has numerous disadvantages. For example, the conventional chemical refurbishment process is a multi-step process that requires a significant amount of time to complete. For example, a typical process may include the steps of copper removal, chemical strip, inspection, polishing, and baking. This process often takes more than 24 hours before an ESC is available to have new layers applied.

In addition to the time required for refurbishment, the conventional chemical refurbishment process introduces a significant amount of chemicals that must be recovered, treated, and/or discarded. The multiple chemicals used in this process may introduce hazards to workers and the environment. A large number of chemicals are required because different metals may be used in the layers of the MCA pad, and different chemical stripping processes are required to remove different layers. Further, many different metals may be incidentally deposited on the ESC during wafer processing. Each metal may require a different combination of chemicals for removal.

The conventional chemical refurbishment process is therefore expensive to perform due to the many chemicals, the processing equipment, and the time required. There remains a need in the art for processes that remove the layers and metals on an ESC during refurbishment that can be performed faster, with a lower cost, and without the use of a multistep chemical process.

### BRIEF SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In one aspect, a method to refurbish electrostatic chucks is provided. The method includes identifying one or more layers on an MCA pad affixed to an electrostatic chuck, configuring a laser ablation system to remove the identified layers, ablating the identified layers with a controlled laser beam from the laser ablation system, identifying one or more deposited products such as metals, and deposition byproducts such as carbon, on the electrostatic chuck, and ablating the identified deposited metals with the laser beam. In another aspect, the MCA pad may include a DLC layer and a Ti-TiN layer. The one or more deposited metals may include aluminum, copper, tantalum, tantalum nitride, titanium, titanium nitride, cobalt, tungsten, molybdenum, nickel, ruthenium, silicon, silicon nitride, zirconium, hafnium, gold, and ferrous oxide.

In another aspect, the laser ablation system includes a first laser source and/or a second laser source. In another aspect, the laser ablation system includes a single laser source. The laser beam may have a wavelength shorter than 1.2um, a pulse width of less than 10 ns, and a pulse repetition rate above 100 kHz. In another aspect, one or more portions of the electrostatic chuck are not ablated to allow a portion of the MCA pad to remain. In another aspect, the method may also include performing a plasma cleaning process utilizing reactive ion etching to remove any residual substance on the electrostatic chuck after the ablating of the layers and the deposited metals. In another aspect, the method may also include using a first laser source of the laser ablation system that is configured to ablate substances on the electrostatic chuck with a first set of laser parameters and a second laser source laser ablation system configured to ablate substances on the electrostatic chuck with a second set of laser parameters.

In another aspect, a laser ablation system is provided that includes a laser source configured to produce a laser beam, laser optics configured to focus the laser beam and to position the laser beam, a translation stage to carry an electrostatic chuck, and a control system configured to direct the laser source, the optics, and the positioning mechanism to ablate each layer of an MCA pad on an electrostatic chuck.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. The accompanying drawings illustrate exemplary approaches of the disclosure, including the practical application of the principles thereof, as follows:

FIG. 1 illustrates an ESC in accordance with one or more embodiments;

FIG. 2 illustrates layers of an ESC for removal via laser ablation in accordance with one or more embodiments;

FIG. 3 is a schematic representation of a laser ablation system in accordance with one or more embodiments; and

FIG. 4 illustrates an example method to enable refurbishment of electrostatic chucks in accordance with one or more embodiments.

### DETAILED DESCRIPTION

Processes in accordance with the present disclosure will now be described more fully hereinafter with reference to the accompanying drawings, where various embodiments are shown. The processes may be embodied in many different forms and are not to be construed as being limited to the embodiments set forth herein. Instead, these embodiments are provided so the disclosure will be thorough and complete, and will fully convey the scope of the methods to those skilled in the art.

The terminology used herein is for the purpose of describing particular embodiments only and is not intended to be limiting of the presently disclosed subject matter. While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The processes of the current technology use laser ablation to remove layers of an MCA pad and deposited metals from an ESC to prepare the substrate of the ESC for refurbishment. The laser ablation will cause minimal damage or no damage to the substrate. The laser ablation will prepare an ESC for refurbishment in a manner that is faster, less expensive, safer, and with less damage to the substrate than is seen with a conventional chemical refurbishment process.

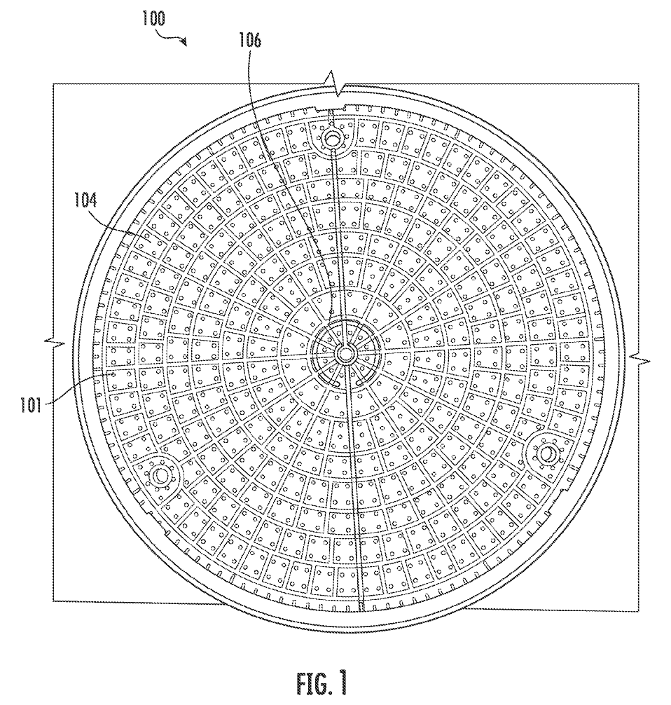

FIG. 1 illustrates an ESC 100 in accordance with one or more embodiments.

The ESC 100 has an MCA pad 101 disposed on a surface of a substrate 104. The MCA pad 101 may include multiple layers such as a DLC coating, a Ti/TiN layer, a center metal circuit pad 106, or any other suitable layer, hardware, or device. In an example, the center metal circuit pad 106 may be constructed of an additional DLC coating and/or Ti/TiN Layer. In the example, the center metal circuit pad 106 may be thicker or additional MCA pad 101. In certain examples, the DLC coating may cover or encapsulate other layers, such as the Ti/TiN layer.

The ESC 100 may further have one or more metals deposited on the surface of the MCA pad 101 and/or the substrate 104, such as from chemical vapor deposition of metals onto wafers being secured by the ESC 100 or from any other processes used in wafer processing. In example embodiments, the metals, partially oxidized metals, or metal compounds including metal nitrides deposited on the MCA pad 101 or the substrate 104 may include but not be limited to one or more of the following: aluminum, copper, tantalum, tantalum nitride, titanium, titanium nitride, cobalt, tungsten, molybdenum, nickel, ruthenium, silicon, silicon nitride, zirconium, hafnium, gold, and ferrous oxide. Typically, a thin film deposited from these metals ranges from 10nm to 10um in thickness. Certain metals, such as ferrous oxide, may be on the assembly.

The processes and methods described herein will remove the MCA pad 101, including the DLC coating 102, a Ti/TiN layer, and/or a center metal circuit pad 106 from the substrate 104. The processes and methods described herein will additionally remove any of the deposited metals from the wafer processing. In certain embodiments, portions of the MCA pad 101 may be intentionally not removed, such as the center metal circuit pad 106.

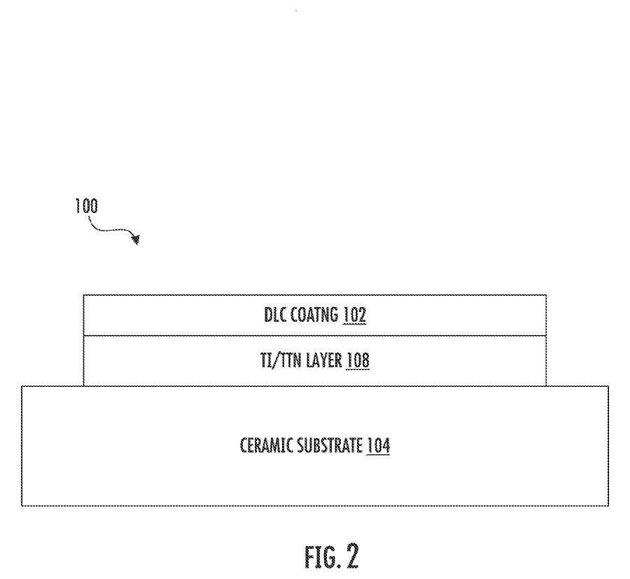

FIG. 2 illustrates layers of an ESC 100 for removal via laser ablation in accordance with one or more embodiments.

As described with respect to FIG. 1, the substrate 104 may have an MCA pad 101 deposited on a top surface. The MCA pad 101 may include a DLC coating 102, a Ti/TiN layer 108, and/or a center metal circuit pad 106. In an example, the center metal circuit pad 106 may be constructed of an additional DLC coating 102 and/or Ti/TiN Layer 108. In the example, the center metal circuit pad 106 may be thicker or additional MCA pad 101. In FIG. 2, a substrate 104 is depicted as a bottom layer of the ESC 100. The substrate 104 may be of any suitable thickness to serve the functions of the ESC 100 as described herein. In examples, the substrate 104 is greater than 1mm in thickness, such as 1.5, 2, 3, 5, 10, 20, or 50mm thick.

A first layer depicted on the substrate 104 is a Ti/TiN layer 108. This layer may be any suitable thickness to serve the functions of the ESC 100 as described herein. In examples, the Ti/TiN layer 108 is less than 10um thick, such as 0.2, 0.4, 0.6, 0.8, 1.0, 1.5, 2.0, 2.5, 3, 5, 7 or 9um thick.

A top layer depicted on the substrate 104 is a DLC coating 102. This layer may be any suitable thickness to serve the functions of the ESC 100 as described herein. In examples, the DLC coating 102 is less than 10um thick, such as 0.2, 0.4, 0.6, 0.8, 1.0, 1.5, 2.0, 2.5, 3, 5, 7 or 9um thick.

In conventional systems, chemical stripping is used to remove a Ti/TiN layer 108 and a DLC coating 102. The chemical stripping processes typically use a mixture of acids to strip the coatings on the substrate 104. This portion of the chemical stripping process typically requires several hours to remove the layers. When the substrate 104 is exposed to the chemical stripping materials, the surface of the substrate 104 may be damaged by etching or other reactions from the chemicals.

The surface of the substrate 104 receives some level of observable etching damage after a first period of time. In an example, the first period of time may be 30 minutes, 60 minutes, or 90 minutes.

After a second period of time being exposed to the chemical stripping process, the surface of the substrate 104 exhibits increased etching damage. The etching in the surface of the substrate 104 after the second period of time may cause grooves, channels, pits, and other imperfections to be etched into the surface. In an example, the second period of time may be 120 minutes or 180 minutes.

In the example, after a third period of time, such as 240 minutes or more, of exposure to the chemical stripping process, the surface of the substrate 104 exhibits an additional level of etching damage such that the substrate 104 is unusable for use as a refurbished ESC 100. In certain examples, additional processing steps may be employed to make the substrate 104 usable, such as by baking the substrate 104. The etching into the substrate 104 reduces the number of times an ESC 100 may be refurbished because the substrate 104 becomes thinner at each chemical stripping and subsequent processing steps.

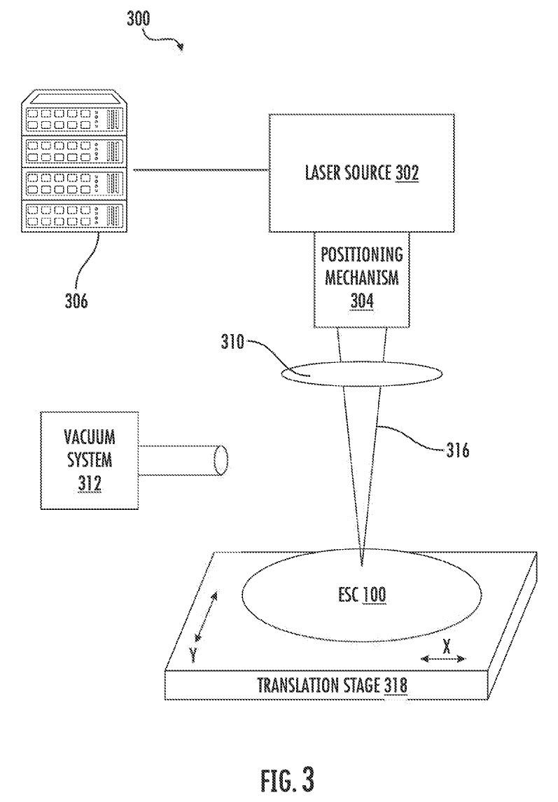

FIG. 3 is a schematic representation of a laser ablation system 300 in accordance with one or more embodiments.

To overcome the deficiencies of the conventional chemical refurbishment process, the processes and methods described herein will remove the MCA pad 101 and any deposited metals on an ESC 100 with a process of laser ablation. The laser ablation process removes the MCA pad 101 and the metals and metal compounds with little or no damage to the substrate 104. The substrate 104 after laser ablation requires a lesser amount of polishing time because the substrate 104 is not subjected to the harsh chemical stripping process.

The laser ablation system 300 is configured to provide laser beams 316 with parameters that are capable of removing each layer of component of the MCA pad 101, including a DLC coating 102 and a Ti/TiN layer 108. The laser ablation system 300 is configured to provide laser beams 316 with parameters that are capable of removing the metals deposited on the MCA pad 101 or the substrate 104 including one or more of the following: aluminum, copper, tantalum, tantalum nitride, titanium, titanium nitride, cobalt, tungsten, molybdenum, nickel, ruthenium, silicon, silicon nitride, zirconium, hafnium, gold, and ferrous oxide.

The laser ablation system 300 is able to remove the MCA pad 101 and any deposited metals faster than the chemical stripping process with fewer steps and fewer imposed health hazards. Steps such as substrate 104 polishing reduced or eliminated because the laser does not etch the surfaced of the substrate 104 as chemical stripping does. Because the process is faster, more ESCs 100 are able to be processed in a given time. Further, because less damage is received on the surface of the substrate 104, the ESCs 100 may be refurbished a greater number of times than with chemical stripping.

The laser ablation system 300 may include laser optics 310 to condition the profile and size of the laser beam 316. The laser optics 310 may include such features as beam shaping optics and a beam expander/collimator. The laser optics 310 may further include a fast laser beam positioning mechanism 304. The positioning mechanism 304 may include a linear stage with a galvanometer (galvo) scanner, or polygon scanner, or a hybrid polygon/galvo scanner for maximum scanning speed and scan field.

A galvo scanner is a motorized mirror system that may be used to steer a laser beam 316 over a surface. Galvo scanners move the laser beam 316 accurately and precisely over small surfaces using dynamic electro-optical components. A polygon scanner may have a polygon shaped component that has mirrored surfaces connected end to end to create a polygon. The polygon is spun on a motor shaft to allow the laser beam to be scanned quickly. In one embodiment, a Galvo/polygon hybrid scanner is adopted to enable scanning speeds above 10 m/s, such as at 50m/s, 200 m/s, or 400 m/s.

The laser ablation system 300 may be automated by a control system 306. The control system 306 may be a computing device or other programable electronic device that automates the regions and directions to direct the laser beam 316. For example, the control system 306 may direct the positioning mechanism 304, the laser source 302, and/or the optics 310 to move the laser beam 316 over a particular region of an ESC 100.

When multiple ESCs 100 have a similar MCA pad 101 configuration, an automated laser ablation system 300 may be used to remove the MCA pads 101 with minimal user interaction. The laser beams 316 are directed to the regions of the ESC 100 from which any surface material should be removed automatically.

MCA pads 101 typically have a discrete distribution such that the location of the materials in the MCA pad 101 are known and repeated. Thus, when an MCA pad 101 is being removed, to improve the process throughput while avoiding substrate damage, the laser ablation system 300 may be operated in a free triggering mode. The free triggering mode allows the laser beam 316 to scan at a high speed without interruption. In this process, the laser beam 316 is triggered on at known MCA pad locations and off when not at a known MCA pad 101 location.

The laser ablation system 300 may include a laser source 302. The laser source 302 may be a solid state laser with a wavelength below 1.2 um, and pulse width below 10 ns, pulse repetition frequency above 100 kHz, and a Gaussian beam profile (M² <1.3). Laser sources 302 with alternative characteristics may be configured for different types of MCA pads 101 or different types of metal deposits on the substrate 104.

In an example embodiment, a laser beam 316 has a wavelength in the UV range, shorter than 360 nm, and with a pulse width less than 15 ps. In one example, the pulse width is 3 ps with a pulse repetition rate above 1 MHz, and a laser average power above 50 W, preferably above 100 W. In the example, the laser has a focused beam of 50 um in diameter or less, preferably less than 15 um.

Different types of laser ablation systems 300 that may be configured to produce the laser beam 316 of the example may be a fiber laser, a rod crystal laser, or a disc laser. A preferred laser type for these applications is a slab laser, such as an innoslab laser. Innoslab lasers are able to deliver a high pulse energy and high average power in the range of 80 W to 200 W @ ~350 nm UV.

The UV laser wavelength maximizes photon absorption in all different materials, such as the MCA pads 101 and various deposited metals, to improve the selective ablation of MCA pads 101 and metals over the substrate 104 substrate. The laser ablation system 300 has a seed laser frequency of at least 50 MHz, and preferably above 500 MHz. In one example, the seed laser frequency is at 1 GHz or higher, so that a burst of pulses can be operated at different frequency, such as 500 KHz, 1 MHz, or2 MHz.. The number of pulses in a burst can be programmed, such as 1 pulse, 5 pulses, 10 pulses, or other suitable numbers of pulses. The temporal profile of the burst, i.e., the envelope for the pulses in a burst, can be also programmed, such as a rectangular shaped burst profile, a triangular shaped burst profile, a Gaussian-type bell shaped burst profile, or other more complicated burst profile. The spatial profile of the laser beam can be adjusted with appropriate optic modules, such as a circular Gaussian shape, a line-shaped beam profile that in the long axis direction laser intensity profile is uniform while the short axis direction laser intensity profile is Gaussian type, or other more complicated spatial beam profile.

In an example embodiment, a single laser source 302 is used to completely remove MCA pads 101 and deposited metals. However, an alternative embodiment may utilize one laser source 302 process to remove one portion of MCA pad 101 and metal materials, while a second laser source, or separate laser ablation system, is adopted to completely remove any residual material left over in order to avoid/reduce damage to the substrate 104. The second laser ablation system 300 can use either the same laser source 302 with different process parameters or a different laser source. In one example, the first laser source 302 may have parameters that more aggressively remove metals, such as with a higher number of pulses per burst, such as 10 pulses per burst. In the example, the second laser source may have parameters that are less aggressive to prevent additional damage to the substrate 104.

In an alternate embodiment, the process may use a first laser source 302 to remove most of an MCA pad 101 and deposited metals from a substrate 104 and then employ a plasma cleaning process to remove any residual DLC coating 102. The plasma cleaning process may utilize a reactive ion etch process. Experiments performed using this process indicate that after a first laser process, a thin DLC coating 102 at the periphery of MCA pad 101 remained. The remaining DLC coating 102 was typically less than 0.5 um thick. In some embodiments, thin layers, such as at an edge of the MCA pad 101, may be thin difficult to remove by laser without causing damage to the substrate 104. When the remaining DLC coating 102 is has been ablated until a layer is thinner than a configured threshold, a plasma cleaning process may eliminate the remaining DLC coating 102.

In example embodiments, a layer of atmospheric carbon may incidentally be deposited on ESCs 100. For example, in high temperature ESCs 100, enough atmospheric carbon may be deposited such that removal is necessary for proper refurbishment of the substrate 104. The laser ablation system 300 may be tuned to remove the atmospheric carbon along with the MCA pad 101 removal or at any other suitable time.

In example embodiments, operators may desire to leave certain portions of the MCA pad 101 on the substrate 104. For example, while all other materials of the MCA pad 101 are removed from the substrate 104, a center metal circuit pad 106 is to remain. To allow a portion of the MCA pad 101 to remain intact on the substrate 104, the laser source 302 may be configured to ignore certain sections of the substrate 104. For example, software or hardware controlling the direction of the laser beam 316, such as the positioning mechanism 302 or the optics 310, direct the laser beam 316 to all portions of the substrate 104 except the portion containing the center metal circuit pad 106. Any shape, region, or depth of material on the surface of the substrate 104 may be intentionally ignored by the laser ablation system 300 and remain on the surface of the substrate 104 after the laser ablation process is completed.

In example embodiments, the deposited metals, portions of the MCA pad 101, and other solids may become atomized as dust or otherwise become airborne. The process seeks to capture the airborne particles to prevent the metals from becoming health hazards, re-depositing on the substrate 104, settling on work surfaces, or entering machinery. Further, the metals may be captured to be reused or recycled. The metals may be captured in a vacuum system 312, such as a hood with a filtration system. The metals may be blown by a blower or fan into a filtration system. The laser ablation system 300 may be encompassed by a screen system that prevents metal particles from escaping. The metals may be collected from the screen or other surfaces surrounding the system. In examples, the screen or filtration system to capture the metal particles may be 100 nm to 1 um. In many cases the captured metal particles are water soluble and may be washed away or collected in a solution vessel or vat.

A translation stage component 318 may be used to position the ESC 100. For example, translation stage component 318 may be a motorized component that moves the ESC 100 in linear and/or rotational motions to position the ESC 100 under the laser source 302. The translation stage component 318 may move the ESC 100 in any of six degrees of freedom, such as X, Y, Z, Theta-Z, Theta-X, Theta-Y, and/or Theta-Z. By moving the ESC 100 to particular locations, with a particular height, and with particular rotational positions, the laser beam 316 can reach each location that has material to be removed without damaging the ESC 100.

The translation stage component 318 may be controlled by a computerized control system such as control system 306. Each range of motion may be controlled by a different motor and/or control loop. The translation stage component 318 may provide a platform or other component to support the ESC 100 and maintain positional control over the ESC 100.

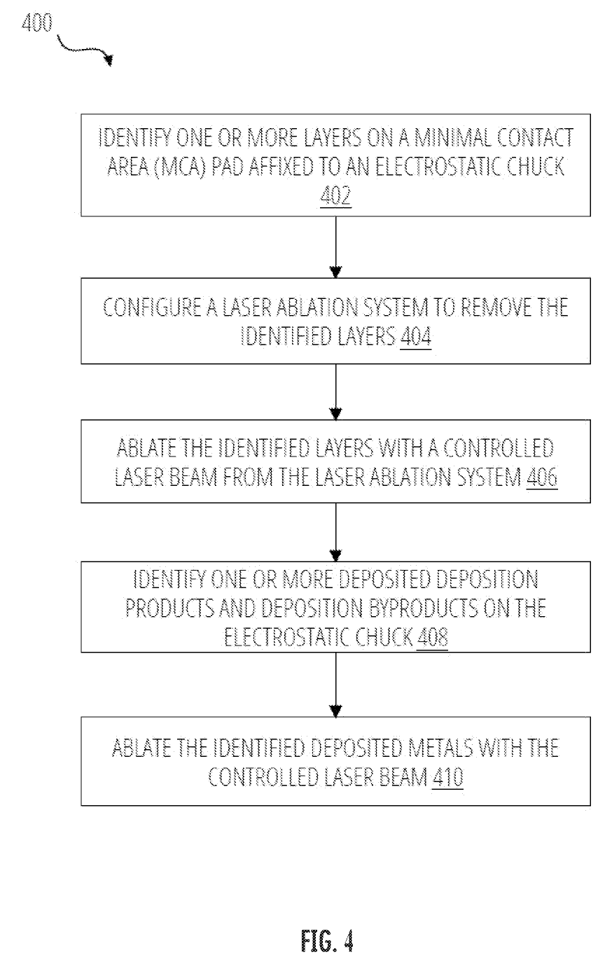

FIG. 4 illustrates an example method 400 to enable refurbishment of electrostatic chucks 101. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In block 402, the method 400 includes identifying one or more layers on a minimal contact area (MCA) pad 101 affixed to an electrostatic chuck 100. The electrostatic chuck 100 may have one or more layers as described with respect to FIG. 1 and FIG. 2.

In block 404, the method 400 includes configuring a laser ablation system 300 to remove the identified layers. As described in FIG. 3, the laser ablation system 300 is configured to provide laser beams 316 with parameters that are capable of removing each layer of component of the MCA pad 101, including a DLC coating 102 and a Ti/TiN layer 108.

In block 406, the method 400 includes ablating the identified layers with a controlled laser beam 316 from the laser ablation system 300.

In block 408, the method 400 includes identifying one or more deposited deposition products and deposition byproducts on the electrostatic chuck 100. As described herein, the deposition byproduct may be carbon, other atmospheric byproducts, or metal or metal compound byproducts.

In block 410, the method 400 includes ablating the identified deposited metals with the controlled laser beam 316. The ablated electrostatic chuck 100 is available to receive a new MCA pad 101 and/or other layers.

What is claimed is:

1. A method to enable refurbishment of electrostatic chucks, comprising:
identifying one or more layers on a minimal contact area (MCA) pad affixed to an electrostatic chuck;
configuring a laser ablation system to remove the identified layers;
ablating the identified layers with a controlled laser beam from the laser ablation system;
identifying one or more deposited deposition products and deposition byproducts on the electrostatic chuck; and
ablating the identified deposited metals with the controlled laser beam.

2. The method of claim 1, wherein the removed layers of the MCA pad comprise a diamond like carbon layer, doped diamond-like carbon layer, a Ti-TiN layer, and/or other wear-resistant coatings.

3. The method of claim 1, wherein the one or more deposited deposition products comprise metals or metal compounds comprise aluminum, copper, tantalum, tantalum nitride, titanium, titanium nitride, cobalt, tungsten, molybdenum, nickel, ruthenium, silicon, silicon nitride, zirconium, hafnium, gold, and ferrous oxide.

4. The method of claim 1, wherein deposition byproducts comprise carbon.

5. The method of claim 1, wherein the laser ablation system comprises a single laser source.

6. The method of claim 1, wherein the laser ablation system comprises a first laser source and/or a second laser source.

7. The method of claim 6, wherein a first laser source of the laser ablation system is configured to ablate substances on the electrostatic chuck with a first set of laser parameters and a second laser source laser ablation system is configured to ablate substances on the electrostatic chuck with a second set of laser parameters.

8. The method of claim 7, wherein the first laser source ablates the substances with a laser beam of a higher intensity than a laser beam of the second laser source.

9. The method of claim 1, wherein the controlled laser beam has a wavelength shorter than 360 nm, a pulse width of less than 15 ps, and a pulse repetition rate above 1 MHz.

10. The method of claim 9, wherein the controlled laser beam has a focused beam with a diameter of less than 50 um.

11. The method of claim 1, wherein a laser source of the laser ablation system is a slab laser.

12. The method of claim 1, wherein a positioning mechanism for the laser beam is a galvanometer scanners, or polygon scanner, or a hybrid polygon/galvanometer scanner.

13. The method of claim 12, wherein the positioning system is configured to perform scanning at speeds of at least 5 m/s.

14. The method of claim 1, wherein one or more portions of the electrostatic chuck are not ablated to allow a portion of the MCA pad to remain.

15. The method of claim 1, wherein a control system automates a laser beam path to ablate a configured region of the electrostatic chuck.

16. The method of claim 1, further comprising performing a plasma cleaning process utilizing reactive ion etching to remove any residual substance on the electrostatic chuck after the ablating of the layers, the deposited deposition products, and the deposition byproducts.

17. The method of claim 1, further comprising collecting airborne particles created from the ablating of the layers and the deposited metals.

18. A laser ablation system, comprising:
a laser source configured to produce a laser beam;
laser optics configured to focus the laser beam and to position the laser beam;
a translation stage to carry an electrostatic chuck; and
a control system configured to direct the laser source, the optics, and the positioning mechanism to ablate each layer of an MCA pad on the electrostatic chuck.

19. The laser ablation system of claim 17, wherein the laser beam produced by the laser ablation system has a wavelength shorter than 1.2 um, a pulse width of less than 10 ns, and a pulse repetition rate above 100 kHz.

20. The laser ablation system of claim 17, wherein the laser source is a slab laser.
